(19) United States
(12) Patent Application Publication
(10) Pub. No.: US 2026/0159125 A1
(43) Pub. Date: Jun. 11, 2026

(54) SYSTEM COMPRISING A MOTOR VEHICLE AND A SERVER, AND METHOD FOR OPERATING THE SYSTEM

(71) Applicant: VOLKSWAGEN AKTIENGESELLSCHAFT, Wolfsburg (DE)

(72) Inventors: Jonas KASTE, Alfeld (DE); Felix STAHL, Braunschweig (DE); Timur AMINEV, Braunschweig (DE)

(21) Appl. No.: 19/408,488

(22) Filed: Dec. 4, 2025

(30) Foreign Application Priority Data
Dec. 9, 2024 (DE) 10 2024 136 739.3

(51) Int. Cl. B60W 60/00; B60W 40/09; B60W 50/00

(52) U.S. Cl. CPC B60W 60/001; B60W 40/09; B60W 50/00; B60W 2050/0043; B60W 2050/0083

(57) ABSTRACT

A method for operating a system that includes a motor vehicle and a server, wherein swarm data includes data sets provided on the server, each data set representing a first variable, relating to longitudinal dynamics, and/or a second variable relating to a driven path, wherein the data sets are allocated to subgroups depending on their first variable or on their second variable, wherein a predefined driver profile is selected based on an input, wherein one of the subgroups is assigned to the selected driver profile, wherein a first control variable for a driver assistance system for automatic longitudinal guidance and/or automatic transverse guidance is determined based on the first variables and/or second variables of those data sets allocated to the subgroup assigned to the selected driver profile, wherein the motor vehicle is automatically longitudinally and/or transversely guided using the driver assistance system depending on the first control variable.

### PRIORITY CLAIM

This patent application claims priority to German Patent Application No. 10 2024 136 739.3, filed 9 Dec. 2024, the disclosure of which is incorporated herein by reference in its entirety.

### SUMMARY

Illustrative embodiments relate to a method for operating a system that includes a motor vehicle which has a driver assistance system for automatic longitudinal and/or transverse guidance, and a server which comprises swarm data. Disclosed embodiments further relate to such a system.

### BRIEF DESCRIPTION OF THE DRAWINGS

Disclosed embodiments will be described with reference to the figures. The features and feature combinations in the description, as well as the features and feature combinations presented in the figures, may be used not only in the combination respectively indicated but also in other combinations or individually, without departing from the scope of the disclosure. In the drawings:

FIG. 1 schematically shows a system comprising a motor vehicle which has a driver assistance system for automatic longitudinal and/or transverse guidance, and a server, external to the motor vehicle, on which swarm data is stored;

FIG. 2 shows a flow diagram of a method sequence for operating the system according to a first variant; and

FIG. 3 shows a flow diagram of a method sequence for operating the system according to a second variant.

### DETAILED DESCRIPTION

Some motor vehicles have driver assistance systems. Such driver assistance systems are used to assist the driver in certain driving tasks and/or to assume a driving task. For example, a driver assistance system can provide a function for automatic longitudinal guidance, for example, in the context of a distance cruise control, and/or for automatic transverse guidance, for example, in the context of lane guidance along a center of a lane.

It is also known to use swarm data for driver assistance systems. Swarm data is data provided by motor vehicles. The data expediently represents a driven road and information about the drive on the road. The information is determined by the motor vehicle using a sensor and/or a camera. The information can represent, for example, the path actually driven on the road (driven lane), for example, represented by the distance from a lane marking of the road, a speed profile and/or an acceleration profile of the motor vehicle along the driven path.

For example, the availability of an existing driver assistance system can be increased based on the swarm data. Swarm data can be used, for example, to derive data about the course (path) to be driven and to enable lane guidance according to this derived course, even if there are no lane markings on the road that would typically be used to determine the course to be driven.

Swarm data also has the advantage that this data comprises actual drives. Thus, data or variables for controlling the motor vehicle by the driver assistance system can be determined based on the swarm data, which represent a comparatively human behavior and perceived by the driver as comparatively pleasant.

However, different drivers may have different preferences. For example, a sporty driver will perceive a different acceleration behavior to be pleasant than a driver who prefers a more fuel-efficient driving style. These different preferences can also lead to reduced driver acceptance when using swarm data for driver assistance systems.

DE 10 2021 207 781 A1 describes a method for adapting an assisted or automated driving function of a vehicle. In the method, a driving behavior of a driver of the vehicle in at least one driving situation is recorded and the recorded driving behavior of the respective driver is evaluated in order to determine an individual driving style of the respective driver. Furthermore, a special parameter set for the assisted or automatic driving function of the vehicle is determined, which effects a driving style adapted to the individual driving style of the respective driver of the assisted or automated driving function of the vehicle, and the special parameter set is used to modify an existing parameter set of the vehicle's assisted or automated driving function.

From DE 10 2022 211 433 A1, a driver assistance system for a vehicle is known, wherein the driver assistance system is configured such that control variables and/or parameters of the driver assistance system can be defined using selectable driving profiles, wherein at least one driving profile can be selected, in which the control variables and/or parameters of the driver assistance system are determined in a position-dependent manner with the aid of swarm data.

Disclosed embodiments provide an optional method for operating a system including a motor vehicle and a server. In particular, using the method, an automatic longitudinal and/or transverse guidance is adaptable to a driver's expectations. Such a system will also be specified.

Details disclosed herein in relation to the method apply, mutatis mutandis, also to the system, and vice versa.

The method is used for operating a system including a motor vehicle, which has a driver assistance system for automatic longitudinal and/or transverse guidance, and a server external to the motor vehicle. This motor vehicle of the system is also referred to below as an “ego vehicle” for better distinguishability in relation to other vehicles.

The term “automatic longitudinal and/or transverse guidance” refers to an assisting longitudinal or transverse guidance according to Level 1 of the SAE J3016 standard, a partially automatic longitudinal and/or transverse guidance according to Level 2 of the SAE J3016 standard, a conditionally automatic longitudinal and/or transverse guidance according to Level 3 of the SAE J3016 standard, highly automatic longitudinal and/or transverse guidance according to Level 4 of the SAE J3016 standard and/or a fully automatic longitudinal and/or transverse guidance according to Level 5 of the SAE J3016 standard. The same interpretation applies to “automatically longitudinally and/or transversely guided”.

For example, the motor vehicle is guided longitudinally, for example, only using the driver assistance system, wherein the driver carries out the transverse guidance themselves. Furthermore, for example, the motor vehicle is guided transversely, only using the driver assistance system, wherein the driver carries out the longitudinal guidance themselves. In a further example, the motor vehicle is guided both longitudinally and transversely only using the driver assistance system, wherein the driver, for example temporarily and/or in a situation-dependent manner, does not carry out either the longitudinal or the transverse guidance.

According to the method provided in accordance with disclosed embodiments, swarm data is provided on the server. The swarm data, for example, was transmitted to the server in advance from a large number of motor vehicles and/or was calculated based on the data transmitted by these vehicles. The swarm data comprises data sets, wherein each data set represents a first variable, for example, associated with the current location of the motor vehicle, i.e., the ego vehicle, and/or a second variable associated with the current location of the motor vehicle, i.e., the ego vehicle. In particular, this means that the first variable and/or the second variable itself is present in the data sets or can be determined in each case from the data sets and become useful. The current location of the vehicle is determined, for example, by a navigation system and/or by a Global Positioning System(GPS).

The first variable is a variable relating to longitudinal dynamics of the motor vehicle, for example, at the current location of the motor vehicle. Thus, the first variable describes the longitudinal dynamics of the motor vehicle that transmitted the data set to the server. For example, the first variable is or represents a speed of this motor vehicle and/or a longitudinal acceleration of this motor vehicle.

The term “acceleration” here refers to the change in speed and can, therefore, refer to both an increase in speed and a reduction in speed (braking).

The second variable is a variable relating to a driven path, for example, at the current location of the vehicle. The second variable thus describes the path of the motor vehicle that transferred the data set to the server. For example, the second variable is or represents a distance of the motor vehicle from a lane marking on the road or from a roadside. The first and/or the second variable is designed, for example, as a parameter, for example, as a number.

According to the method, the data sets of the swarm data are further allocated to subgroups depending on their first variable or on their second variable. In summary, each data set is assigned to one of the subgroups. The number of subgroups is expediently predefined in this case. This assignment expediently takes place using a predefined assignment function, which carries out the classification, for example, depending on the value or the magnitude of the first variable or the second variable. In particular, the data sets whose first or second variables are in a predefined value range may be assigned to the subgroups.

A driver profile is selected from a number of predefined driver profiles. For example, a user input on an input device, such as a touch display, of the motor vehicle is evaluated. For example, these driver profiles are additionally used to adjust a dynamic behavior of the drive of the motor vehicle, such as a gear shifting behavior of a transmission and/or the strength of an acceleration.

One (single) subgroup is assigned to the selected driver profile. A first control variable for the driver assistance system is then determined based on the first variables and/or based on the second variables of the data sets, which are allocated to the subgroup assigned to the selected driver profile. In summary, the data sets are allocated to subgroups and one of these subgroups is assigned to the selected driver profile. The data sets in the subgroup assigned to the driver profile are used to determine the first control variable, the first control variable being determined based on its first and/or second variables.

The motor vehicle (ego vehicle) is then automatically longitudinally and/or transversely guided using the driver assistance system depending on the first variables.

The control parameter may, therefore, not be based on all data sets of the swarm data, but rather only on the data sets of one subgroup. Since the data sets are assigned to the subgroups depending on their first or second variables, for example their magnitudes, the data sets of the subgroups differ in the driving behavior represented by these variables. Based on the input and, thus, the selection of a driver profile and the assigned subgroup. It is, therefore, possible for a user to set the behavior of the driver assistance system differently and/or to adapt it. This is accompanied by increased acceptance of driving using the driver assistance system.

Optionally, the first control variable may be determined using, for example, only the first variables of the data sets of the respective subgroup. The first control variable may, therefore, be determined using a variable that describes the longitudinal dynamics of the motor vehicle. Furthermore, according to this refinement, a further control variable (second control variable) for the driver assistance system may be determined depending on, for example, only the second variables of those data sets that were used to determine the first control variable. The second control variable may, therefore, be determined using a variable that describes the driven path. In summary, both the first and the second control variable are determined based on the data sets that are allocated to the subgroup assigned to the selected driver profile. In other words, the same data sets are used to determine the first and second control variables.

Thus, the same or similar driving behavior according to the classification of the data sets are advantageously achieved for determining the first and the second control variable.

According to an optional embodiment of the method, the data sets may be allocated to the subgroups according to predefined or predefinable percentile ranges for the first variables or the second variables. This means that each subgroup may be assigned a percentile range. For the classification, the percentile ranges, for example, 0 to 20% or 21% to 40% or 41% to 60% or 61 to 80% or 81% to 100%, are, thus, predefined for the first variable or the second variable and all the data sets, whose first variable or second variable is in a common percentile range, are assigned to a common subgroup. For example, the percentile ranges are selected so that they do not overlap. In summary, all data sets may be ordered according to the values of their first or second variables with regard to their values, and the data sets may then be assigned to the corresponding percentile ranges (and, thus, to the respective subgroups).

An “a to b” percentile range is assigned to those data sets that have a first variable or a second variable with a value between the “a” percentile and the “b” percentile for the first or second variable. For example, the driver profile may be assigned the same subgroup for each driving situation. According to an optional embodiment of the method, the assignment of one of the subgroups to the selected driver profile may alternatively be carried out depending on a current driving situation. The current driving situation may be determined, for example, by evaluating measurement data of a sensor of the motor vehicle (ego vehicle) or of image data of its camera. The current driving situation may be appropriately categorized, i.e., classified, in other words, assigned to one of a number of predefined driving situations, such a class being, for example, cornering, starting, accelerating upon recognition of a traffic sign or the like. One of the subgroups may, therefore, be assigned to the current driving situation, for example, depending on the selected driver profile. It may be expedient if different subgroups are assigned for different driver profiles for the same driving situation.

In summary, the behavior of the driver assistance system, i.e., the automatic longitudinal and/or transverse guidance, may also be adapted to the driving situation.

According to an optional refinement of the method, a driving situation following the current driving situation (in time), that is, which will occur in the future, is determined. In other words, the following driving situation is predicted. For example, a probability may be determined with which the predefined driving situations will occur, and, if a threshold value is exceeded by the probability, the respective predefined driving situation is determined as the following driving situation. For this purpose, for example, measurement data of a sensor of the motor vehicle (ego vehicle) or of image data of its camera are evaluated accordingly.

In this refinement, one of the subgroups may be assigned to the following driving situation and a third control variable for the driver assistance system is determined based on the first and/or the second variables of the data sets of this subgroup. Furthermore, the third control variable is used, that is, the vehicle is automatically longitudinally and/or transversely guided by the driver assistance system depending on the third control variable, (temporally) before the following driving situation occurs. In this case, the transition from the control based on the first control variable to the control based on the third control variable expediently takes place continuously, for example, a continuous transition between the first and the third control variable takes place.

This makes it possible to avoid an abrupt transition, which can be perceived as unpleasant by the driver, or at least reduce the risk of this occurring.

According to an optional embodiment of the method, in the case of automatic longitudinal and/or transverse guidance of the motor vehicle using the driver assistance system, that is, while the motor vehicle is automatically guided by the driver assistance system, a number of manual interventions by the driver is counted. A manual intervention is to be understood as manually aborting the automatic longitudinal and/or transverse guidance and/or performing a manual override, such as manual steering and/or manual acceleration.

If the number of manual interventions is greater than a predefined threshold, a fourth driver assistance control variable is determined based on the first variables and/or second variables of the data sets of one of the subgroups which are not assigned to the selected driver profile. In particular, for determining the fourth control variable, the data sets of one of the subgroups are used, which is assigned to a percentile range that is adjacent or closest to the percentile range of the subgroup assigned to the selected driver profile.

The driver assistance system is then operated according to the fourth control variable, i.e., the vehicle is automatically longitudinally and/or transversely guided depending on the fourth control variable by the driver assistance system.

In summary, in the case of a comparatively frequently occurring intervention by the driver, the subgroup and the control variable are adapted accordingly. In further summary, the first control variable and the fourth control variable are determined from the data sets of different subgroups.

According to an expedient embodiment, a change from the selected driver profile (current driver profile) to another, i.e., next, driver profile is carried out if or as soon as the difference between the first control variable, i.e., the control variable corresponding to the selected driver profile, and a control variable assigned to the next driver profile is less than a predefined threshold value. Such a change in the driver's profile takes place, for example, as a result of an input by the driver.

In this way, changing the driver's profile is perceived by the driver as comparatively pleasant.

According to an optional embodiment of the method, to determine the first control variable the mean value of the first variables or of the second variables of those data sets which are allocated to the subgroup assigned to the selected driver profile is determined. The mean value determined in this manner is then used as the first control variable. The first control variable is therefore the mean value of the first variables or the second variables of the data sets which are allocated to the subgroup assigned to the selected driver profile.

The second, third, fourth and/or fifth control variable may be determined in an analogous manner. In particular, the second control variable is the mean value of the second variables of those data sets which are allocated to the subgroup assigned to the selected driver profile. In particular, the third control variable is the mean value of the first variables or the second variables of the data sets of the subgroup which is assigned to the following driving situation. In particular, the fourth control variable is the mean value of the first variables or the second variables of the data sets of one of the subgroups which are not assigned to the selected driver profile. In particular, the fifth control variable is the mean value of the first variables or the second variables of the data sets of those subgroups, which are assigned to the next driver profile.

According to an optional embodiment of the method, the first control variable, the second control variable, the third control variable, the fourth control variable and/or the fifth control variable is or comprises in each case a target speed, a target acceleration and/or a target path (target course) for the motor vehicle for the automatic longitudinal and/or transverse guidance of the motor vehicle. The speed, acceleration and/or the course (to be driven) of the motor vehicle is expediently set automatically according to these control variables, for example, without the driver guiding the motor vehicle. For example, the target path is represented by a target distance from a lane marking on the road. The target path is, therefore, used for lane guidance of the vehicle.

A further aspect of the disclosed embodiments relates to such a system, which comprises the vehicle and the server. In this case, the motor vehicle and the server may have means for carrying out the method in one of the variants disclosed above. In particular, the motor vehicle and the server may each comprise a control unit (controller) as the means. For example, the driver assistance system of the motor vehicle is or comprises its control unit.

The server may comprise a computer-readable medium connected to its control unit for data transfer, for example a hard disk, on which the swarm data are stored. Furthermore, a computer program is expediently stored on the computer-readable medium of the server and on a computer-readable medium of the motor vehicle, for example, an additional hard disk, each of the computer programs comprising commands that cause the system to carry out the operations of the method.

Equivalent parts and dimensions are provided with identical reference numerals in all figures.

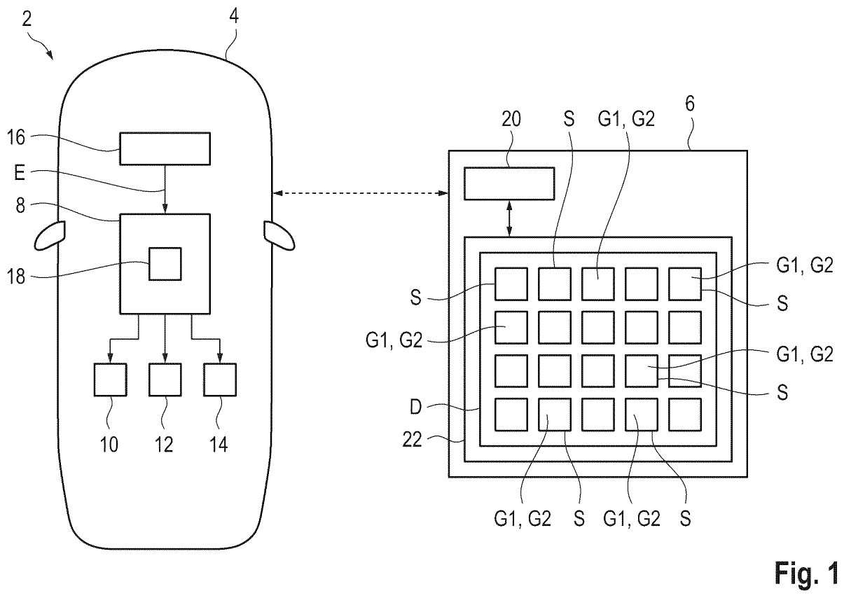

FIG. 1 shows a system 2 which comprises a motor vehicle 4 and a server 6 external thereto. The motor vehicle 4 is connected and/or connected to the server 6 for signal and/or data transmission. The motor vehicle 4 comprises a driver assistance system 8. This is intended and configured to automatically guide the motor vehicle 4 longitudinally and/or transversely. For this purpose, the driver assistance system 8 is connected to a drive 10, a brake 12 and/or a steering 14 of the motor vehicle 4 and can control the drive 10, the brake 12 and/or the steering 14. The motor vehicle 4 also comprises an input device 16, such as a button, a lever or a touch display, so that a user of the motor vehicle 4 can enter an input E.

Furthermore, the motor vehicle 4 may have a (first) control unit 18, which is designed, for example, as a controller. This may be integrated in the driver assistance system 8 according to the exemplary embodiment shown. Alternatively, the first control unit 18 is separate from the driver assistance system 8, but is connected thereto for signal and/or data transmission.

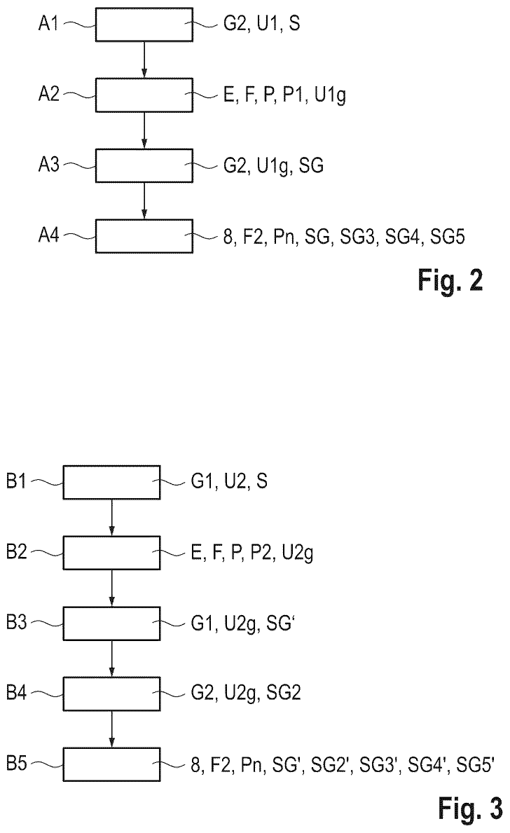

The server 6 comprises a (second) control unit 20, which is designed, for example, as a controller. In this case, the motor vehicle 4, for example, its first control unit 18, can be or is connected for data transmission to the server 6, for example, its second control unit 20, which is represented in FIG. 1 with the double arrow shown by a dashed line. The two control units 18, 20 may form means via which the system 2 according to the method described in FIGS. 2 and 3 can be, and/or is, operated.

Furthermore, the server 6 comprises a computer-readable medium 22 (memory 22) connected to its control unit 20, for example a non-volatile memory such as a hard disk. Swarm data D is stored on the computer-readable medium 22. Thus, swarm data D is provided on the server 6. The swarm data D comprise data sets S, for example, a plurality of data sets S, of which only 20 are shown in FIG. 1 for better clarity. Each of the data sets S represents a first variable G1 and a second variable G2 in addition to or alternatively to the first variable.

The first variable G1 is a variable relating to longitudinal dynamics, for example a speed or a longitudinal acceleration at the current location of the motor vehicle 4 of the system 2. The second variable G2 is a variable relating to a path at the current location of the motor vehicle 4 of the system 2. For example, the respective path represents a distance from a lane marking on the road or from a roadside. The first and/or second variable G1, G2, for example, is/are formed as a parameter, for example, as a number.

FIG. 2 shows a first variant of a method for operating the system 2 of FIG. 1. In a first operation A1, for example, based on the server 6, the data sets S of the swarm data D provided on the server 6 are allocated to subgroups U1 depending on their second variable G2. Each data set S is thus assigned (allocated) to a subgroup U1. This assignment may be based on a predefined assignment function expediently stored on the computer-readable medium 22, which carries out the classification, for example, depending on the value or the magnitude of the second variable G2.

According to the exemplary embodiment shown, for this purpose all data sets S are ordered, for example, according to the value of their second variable G2 and the respective percentile is determined for the second variable G2 of each data set S.

Furthermore, non-overlapping percentile ranges are expediently predefined, wherein each subgroup U1 is assigned to one of the percentile ranges. Each data set S is assigned to the percentile range (and thus to the subgroup U1) in which the determined percentile for its second variable G2 is located. In summary, the data sets S may be allocated to subgroups U1 according to predefined percentile ranges for the second variables G2.

A number of driver profiles P is also predefined. In a second operation A2, one of these driver profiles P may be selected based on an input E by a user of the motor vehicle 4. The selected driver profile is also referred to below as the selected driver profile P1. The input E advantageously takes place in this case using the input device 16 of the motor vehicle 4. In particular, data relating to the selected driver profile P1 is transmitted from the motor vehicle 4 to the server 6.

The selected driver profile P1 may be assigned to one of the subgroups U1 in a predetermined manner or according to a further input of the user at the input device 16.

Optionally, the assignment of one of the subgroups U1 to the selected driver profile P1 takes place depending on a current driving situation F of the motor vehicle 4. For example, this assignment takes place in a predetermined manner or according to a user input. In summary, one of the subgroups U1 is assigned to the selected driver profile P1, wherein this assignment optionally depends on the current driving situation F of the motor vehicle 4. In further summary, one of the subgroups U1 is selected according to the selected profile and, if necessary, according to the driving situation F. This subgroup U1 is also referred to below as the selected subgroup U1g.

The current driving situation F is determined, for example, based on sensor data of a sensor or based on image data of a camera of the motor vehicle 4, for example, by the driver assistance system 8.

The driving situation F represents a straight line, starting, cornering, or a speed adjustment to a modified permitted maximum speed.

Operation A2 can be carried out simultaneously, in advance of or after operation A1.

In a third operation A3, a first control variable SG for the driver assistance system 8 is determined based on the second variables G2 of the data sets S of the selected subgroup U1g. For this purpose, the mean value of the second variables G2 of these data sets S may be determined, and this mean value may be used as the first control variable SG. The first control variable SG, therefore, represents an average path, which is determined (only) from the data sets S of the selected subgroup U1g. This first control variable SG is used as the target path for the motor vehicle 4 for the automatic longitudinal and/or transverse guidance by the driver assistance system 8.

Accordingly, in a fourth operation A4, the motor vehicle 4 may be automatically longitudinally and/or transversely guided using the driver assistance system 8 depending on the first control variable SG, i.e., along the target path.

A driving situation F2 following the current driving situation F, i.e., a future driving situation that has not yet occurred, is optionally determined during operation A4. In other words, the following driving situation F2 is predicted. In an analogous manner to determining the first control variable SG, one of the subgroups U1 is assigned for the following driving situation F2 for the selected driver profile in a predetermined manner or according to an input by the driver. A third control variable SG3 is determined based on the second variable G2 of the data sets S of this subgroup U1 by calculating the mean value of these second variables 2. This third control variable SG3 may be used before the following driving situation F2 occurs, for example, the motor vehicle 4 is automatically longitudinally and/or transversely guided using the driver assistance system 8 depending on the third control variable SG3, and no longer depending on the first control variable SG.

Optionally, if the selection of one of the subgroups, i.e., the assignment of one of the subgroups U1 to the selected driver profile P1, takes place according to a (manual) input by the driver, a number of manual interventions by the driver is counted while the motor vehicle 4 is automatically longitudinally and/or transversely guided using the driver assistance system 8. If the number of manual interventions is greater than a predefined threshold value, a fourth control variable SG4 is determined for the driver assistance system 8 and the motor vehicle 4 may be longitudinally and/or transversely guided automatically depending on this fourth control variable SG4.

The mean value of the second variable G2 of the data sets S of one of the subgroups U1, which was not used for determining the first control variable SG, i.e., which are not assigned to the selected subgroup U1g, may be used as the fourth control variable SG4. In summary, the first control variable SG and the fourth control variable SG4 are determined from the data sets S of different subgroups U1.

Optionally, during operation A4, the selected driver profile P1 may be changed to a next driver profile Pn. This is based on an input by the driver, for example. This change my be carried out if or as soon as the difference between the currently used control variable, for example, the first control variable SG, and a fifth control variable SG5 assigned to the next driver profile Pn is less than a predefined threshold value. The fifth control variable SG5 is, for example, the mean value of the second variables G2 of the data sets S of the subgroup U1 assigned to the next driver profile Pn in a predetermined manner.

In an alternative second variant of the method, which is shown in FIG. 3, in a first operation B1, for example, based on the server 6, the data sets S of the swarm data D provided on the server 6 are allocated to subgroups U2 depending on their first variable G1. This assignment is based on a predefined assignment function expediently stored on the computer-readable medium 22, which carries out the classification, for example, depending on the value or the magnitude of the first variable G1. According to the exemplary embodiment shown, for this purpose, the data sets S are ordered according to the value of their first variable G1 and the respective percentile is determined for the second variable G1 of each data set S.

Furthermore, non-overlapping percentile ranges are expediently predefined, wherein each subgroup U2 is assigned to one of the percentile ranges. Each data set S may be assigned to the percentile range (and thus to the subgroup U2) in which the given percentile for its first variable G1 is located. In summary, the data sets S are allocated to subgroups U2 corresponding to predefined percentile ranges for the first variables G1.

In an analogous manner to the method according to FIG. 2, the number of driver profiles P is predefined, wherein in a second operation B2 one of these driver profiles P is selected based on an input E by a user of the motor vehicle 4. The selected driver profile is also referred to below as the selected driver profile P2. The input advantageously takes place in this case using the input device 16 of the motor vehicle 4. In particular, data relating to the selected driver profile P2 is transmitted from the motor vehicle 4 to the server 6.

The selected driver profile P2 is assigned to one of the subgroups U2 in a predetermined manner or according to a further input of the user at the input device 16.

Optionally, in an analogous manner to the method according to FIG. 2, the assignment of one of the subgroups U2 to the selected driver profile P2 takes place depending on the current driving situation F of the motor vehicle 4. For example, this assignment takes place in a predetermined manner or according to a user input. In summary, one of the subgroups U2 is assigned to the selected driver profile P2, wherein this assignment optionally depends on the current driving situation F of the motor vehicle 4. In further summary, one of subgroups U2 is selected according to the selected profile P2 and, if necessary, according to the current driving situation F. This subgroup U2 is also referred to below as the selected subgroup U2g.

Operation B2 can be carried out simultaneously, in advance of or after operation B1.

In a third operation B3, a (further) first control variable SG′ for the driver assistance system 8 is determined based on the first values G1 of the data sets S of the selected subgroup U2g. For this purpose, the mean value of the first variables G1 of these data sets S is determined, and this mean value is used as the (further) first control variable SG′. This first control variable SG′, therefore, represents, for example, an average speed or an average acceleration, which is determined (only) from the data sets S of the selected subgroup U2g. This first control variable SG′ is used as the target speed or as the target acceleration for the motor vehicle 4 for the automatic longitudinal and/or transverse guidance by the driver assistance system. In summary, the first variables G1 are (only) used for determining the (further) first control variable SG′.

In a fourth operation B4, a second control variable SG2 for the driver assistance system 8 is determined depending on the second variables G2 of the data sets S which were used to determine the (further) first control variable SG′. In other words, the second variables G2 of the data sets S of the selected subgroup U2g are used for determining the second control variable SG2. The mean value of the second variable G2 of these data sets S is used as the second control variable SG2. The second control variable SG2 therefore represents an average path, which is determined (only) from the data sets S of the selected subgroup U2g. This second control variable SG2 is used as the target path for the motor vehicle 4 for the automatic longitudinal and/or transverse guidance by the driver assistance system.

Accordingly, in a fifth operation B5, the motor vehicle 4 is automatically longitudinally and/or transversely guided using the driver assistance system 8 depending on the (further) first control variable SG′ and depending on the second control variable SG2.

During operation B5, the driving situation F2 following the current driving situation F, i.e., a future driving situation that has not yet occurred, is optionally determined. In other words, the following driving situation F2 is predicted. One of the subgroups U2 is assigned to the following driving situation F2 for the selected driver profile P2 in a predetermined manner or according to an input by the driver. A (further) third control variable SG3′ is determined based on the first variables G1 of the data sets S of this subgroup U2 by calculating the mean value of these first variables G1. This (further) third control variable SG3 is used before the following driving situation F2 occurs, for example, the motor vehicle 4 is longitudinally and/or transversely guided automatically using the driver assistance system 8 depending on the (further) third control variable SG3, and no longer depending on the (further) first control variable SG. Alternatively or in addition to this, a (further) second control variable SG2′ is determined based on the second variables G2 of the data sets S of this subgroup U2, i.e., the subgroup U2 assigned to the following driving situation F2, by calculating the mean value of these second variables G2. This further second control variable SG2′ is used before the following driving situation F2 occurs, for example, the motor vehicle 4 is longitudinally and/or transversely guided automatically using the driver assistance system 8 depending on the further second control variable SG2′, and no longer depending on the second control variable SG2.

Optionally, if the selection of one of the subgroups, i.e., the assignment of one of the subgroups U2 to the selected driver profile P2, takes place according to an input by the driver, a number of manual interventions by the driver is counted during operation B5 while the motor vehicle 4 is longitudinally and/or transversely guided automatically using the driver assistance system 8. If the number of manual interventions is greater than a predefined threshold value, a (further) fourth control variable SG4′ is determined for the driver assistance system 8 and on this basis, the motor vehicle 4 is automatically longitudinally and/or transversely guided depending on this (further) fourth control variable SG4′. The (further) first control variable SG′ or the second control variable SG2 is then expediently replaced by the fourth control variable SG4′.

Optionally, the mean value of the first variables G1 or of the second variables G2 of the data sets S of one of the subgroups U2, which was not used for determining the first control variable SG′, i.e., which are not assigned to the selected subgroup U2g, may be used as the (further) fourth control variable SG4′. In summary, the first control variable SG′ and the (further) fourth control variable SG4′ are determined from the data sets S of different subgroups U1.

Optionally, during operation B5, the selected driver profile P2 is changed to the next driver profile Pn. This is based on an input by the driver, for example. This change may be carried out if or as soon as the difference between the currently used control variable, for example, the first control variable SG′ or the second control variable SG2, and a (further) fifth control variable SG5′ assigned to the next driver profile Pn is less than a predefined threshold value. The (further) fifth control variable SG5′ is, for example, the mean value of the first variables G1 or the second variables G2 of the data sets S of the subgroup U2 assigned to the next driver profile Pn in a predetermined manner. The motor vehicle 4 is then longitudinally and/or transversely guided automatically depending on this (further) fifth control variable SG5′.

The first control variables SG, SG′, the second control variables SG2,SG2′, the third control variables SG3,SG3′, the fourth control variables SG4,SG4′ and/or the fifth control variables SG5,SG5′ may be determined in each case based on the server 6, for example, its control unit 20, and transmitted to the motor vehicle 4, for example, to its driver assistance system 8.

Disclosed embodiments are not limited to the exemplary embodiments described above. Instead, other variants can also be derived from within the claims by the person skilled in the art, without departing from the subject-matter of the invention. In particular, all individual features described in connection with the exemplary embodiments and/or in the claims can also be combined together in different ways without departing from the subject matter of the invention.

### LIST OF REFERENCE SIGNS

2 system
4 motor vehicle
6 server
8 driver assistance system
10 drive
12 brake
14 steering
16 input device
18 motor vehicle control unit
20 server control unit
22 computer-readable medium
D swarm data
E input
S data set
G1 first variable
G2 second variable
U1, U2 subgroup
U1g, U2g selected subgroup
P driver profile
SG, SG′ first control variable
SG2, SG2′ second control variable
SG3, SG3′ third control variable
SG4, SG4′ fourth control variable
SG5, SG5′ fifth control variable
F current driving situation
F2 following driving situation
P driver profile
P1, P2 selected driver profile
Pn next driver profile
A1 allocating the data sets to subgroups
A2 selecting a driver profile
A3 determining the first control variable
A4 automatic guidance by the driver assistance system
B1 allocating the data sets to subgroups
B2 selecting a driver profile
B3 determining the first control variable
B4 determining the second control variable
B5 automatic guidance by the driver assistance system

1. A system comprising:
a transportation vehicle; and
a server,
wherein the transportation vehicle and the server are configured to collectively cooperate to provide swarm data including data sets on the server, each data set representing a first variable relating to longitudinal dynamics associated with a current location of the transportation vehicle, and/or a second variable relating to a driven path associated with the current location of the transportation vehicle,
wherein the data sets are allocated to subgroups depending on their first variable or on their second variable,
wherein from a number of predefined driver profiles one of the driver profiles is selected based on an input,
wherein one of the subgroups is assigned to the selected driver profile,
wherein a first control variable for a driver assistance system for automatic longitudinal guidance and/or automatic transverse guidance is determined based on the first variables and/or second variables of those data sets which are allocated to the subgroup assigned to the selected driver profile, and
wherein the transportation vehicle is automatically longitudinally and/or transversely guided using the driver assistance system depending on the first control variable.

2. The system of claim 1, wherein the first variables are used in determining the first control variable, and a second control variable for the driver assistance system is determined depending on the second variables of the data sets which were used to determine the first control variable.

3. The system of claim 1, wherein the data sets are allocated to the subgroups according to predefined percentile ranges for the first variables or the second variables.

4. The system of claim 1, wherein one of the subgroups is assigned to the selected driver profile depending on a current driving situation.

5. The system of claim 4, wherein
a driving situation following the current driving situation is determined,
one of the subgroups is assigned to the following driving situation and a third control variable is determined based on the first variables and/or of the second variables of the data sets of this subgroup, and
the third control variable is used before the following driving situation occurs.

6. The system of claim 1, wherein, in the case of automatic longitudinal and/or transverse guidance of the transportation vehicle using the driver assistance system, a number of manual interventions by the driver is counted, wherein, if the number of manual interventions is greater than a predefined threshold, a fourth control variable is determined for the driver assistance system based on the first variables or the second variables of the data sets of one of the subgroups which are not assigned to the selected driver profile.

7. The system of claim 1, wherein a change from the selected driver profile to a next driver profile is carried out if, or as soon as, the difference between the control variable assigned to the selected driver profile and a fifth control variable, assigned to the next driver profile, is less than a threshold value.

8. The system of claim 1, wherein, to determine the first control variable the mean value of the first variables or the second variables of those data sets which are allocated to the subgroup assigned to the selected driver profile is determined, and that this mean value is used as the first control variable.

9. The system of claim 1, wherein the first control variable, the second control variable, the third control variable, the fourth control variable and/or the fifth control variable is or comprises in each case a target speed, a target acceleration and/or a target path for the transportation vehicle for the automatic longitudinal and/or transverse guidance of the transportation vehicle.

10. A method for operating a system including a transportation vehicle and a server, the method comprising:
providing swarm data including data sets on the server, each data set representing a first variable relating to longitudinal dynamics associated with a current location of the transportation vehicle, and/or a second variable, relating to a driven path associated with the current location of the transportation vehicle;
allocating the data sets to subgroups depending on their first variable or on their second variable;
selecting, from a number of predefined driver profiles, one of the driver profiles based on an input;
assigning one of the subgroups to the selected driver profile;
determining a first control variable for a driver assistance system for automatic longitudinal guidance and/or automatic transverse guidance based on the first variables and/or second variables of those data sets which are allocated to the subgroup assigned to the selected driver profile; and
automatically longitudinally and/or transversely guided the transportation vehicle using the driver assistance system depending on the first control variable.

11. The method of claim 10, wherein the first variables are used in determining the first control variable, and a second control variable for the driver assistance system is determined depending on the second variables of the data sets which were used to determine the first control variable.

12. The method of claim 10, wherein the data sets are allocated to the subgroups according to predefined percentile ranges for the first variables or the second variables.

13. The method of claim 10, wherein one of the subgroups is assigned to the selected driver profile depending on a current driving situation.

14. The system of claim 13, wherein
a driving situation following the current driving situation is determined,
one of the subgroups is assigned to the following driving situation and a third control variable is determined based on the first variables and/or of the second variables of the data sets of this subgroup, and
the third control variable is used before the following driving situation occurs.

15. The method of claim 10, wherein, in the case of automatic longitudinal and/or transverse guidance of the transportation vehicle using the driver assistance system, a number of manual interventions by the driver is counted, wherein, if the number of manual interventions is greater than a predefined threshold, a fourth control variable is determined for the driver assistance system based on the first variables or the second variables of the data sets of one of the subgroups which are not assigned to the selected driver profile.

16. The method of claim 10, wherein a change from the selected driver profile to a next driver profile is carried out if, or as soon as, the difference between the control variable assigned to the selected driver profile and a fifth control variable, assigned to the next driver profile, is less than a threshold value.

17. The method of claim 10, wherein, to determine the first control variable the mean value of the first variables or the second variables of those data sets which are allocated to the subgroup assigned to the selected driver profile is determined, and that this mean value is used as the first control variable.

18. The method of claim 10, wherein the first control variable, the second control variable, the third control variable, the fourth control variable and/or the fifth control variable is or comprises in each case a target speed, a target acceleration and/or a target path for the transportation vehicle for the automatic longitudinal and/or transverse guidance of the transportation vehicle.
